(19) United States
(12) Patent Application Publication
(10) Pub. No.: US 2009/0156776 A1
(43) Pub. Date: Jun. 18, 2009

(54) Process for making siloxane oligomer

(76) Inventors: Slawomir Rubinsztajn, Niskayuna, NY (US); Witold Fortuniak, Lodz (PL); Julian Chojnowski, Lodz (PL); Jan Kurjata, Lodz (PL)

Correspondence Address: MOMENTIVE PERFORMANCE MATERIALS INC.;c/o Dilworth & Barrese, LLP, 1000 Woodbury Road, Suite 405, Woodbury, NY, 11797, US

(21) Appl. No.: 12/378,674

(22) Filed: Feb. 18, 2009

Related U.S. Application Data
(63) Continuation of application No. 11/147,097, filed on Jun. 7, 2005.

(30) Foreign Application Priority Data
Apr. 20, 2005 (PL) P-374519

(51) Int. Cl. C08G 77/12

(52) U.S. Cl. 528/31

(57) ABSTRACT

A process for making a Si—H functional siloxane oligomer from the reaction between silicon hydride compositions and cyclic siloxane oligomer in the presence of a Lewis acid is provided. The Lewis acid is operable to interact with the hydrogen of the silicon hydride to promote ring opening of the cyclic siloxane oligomer and the insertion a siloxane oligomer segment between Si and H atom to thereby form the Si—H functional siloxane oligomer.

### BACKGROUND

1. Technical Field

The invention includes embodiments that relate to a method of making a siloxane oligomer.

2. Discussion of Related Art

Silicon hydride (Si—H) functional siloxane oligomers are an important class of siloxane intermediates that have a broad range of industrial applications including precursors for preparation of organofunctional siloxane oligomers, chain extenders and crosslinkers. Oligomers are a short chain polymer molecule consisting of only a small plurality of monomer units, e.g., dimer, trimer, and even dodecamer. Typical processes to make such Si—H functional siloxane oligomers include cohydrolysis of chlorosilanes, heterocondensation of organofunctional silanes, cationic polymerization of cyclosiloxanes in the presence of tetramethyldisiloxane as a chain stopper or by end-capping of silanol stopped oligosiloxanes with dimethylchlorosilane. Such current processes to make Si—H functional siloxane oligomers produce siloxane oligomers with high polydispersity. To date it has been difficult to prepare mono-Si—H functional or telechelic Si—H functional siloxane oligomers or siloxane oligomers with narrow polydispersity.

One process to produce Si—H functional siloxane oligomers with narrow polydispersity is an anionic ring opening polymerization of hexamethyl cyclo trisiloxanes and subsequent quenching of lithium silanolate with chloro dimethyl silane. However, this process may be difficult to conduct at an industrial scale.

It may be desirable to have a new and/or different process for forming a siloxane oligomer.

### BRIEF DESCRIPTION

The invention includes embodiments that relate to a process for making a Si—H functional siloxane oligomer. The process may include reacting one or both of a silicon hydride or a Si—H functional siloxane with a cyclic siloxane oligomer and a Lewis acid. A pendant hydrogen of the silicon hydride or of the Si—H functional siloxane may promote ring opening of the cyclic siloxane oligomer to form a polysiloxane segment. The polysiloxane segment inserts between the hydrogen and the silicon atom from which the hydrogen was pendant.

The invention includes embodiments that relate to a process for making a telomer. The process may include interacting one or both of a silicon hydride or of a Si—H functional siloxane with a Lewis acid. The Lewis acid may interact with a hydrogen that is pendant from a silicon atom of at least one of the silicon hydride or of the Si—H functional siloxane. The interacted hydrogen may promote a ring opening of a cyclic siloxane oligomer. A ring of a cyclic siloxane oligomer may be opened using the interacted hydrogen to form a polysiloxane segment. The polysiloxane segment may insert between the interacted hydrogen and the silicon atom to form a telomer. The telomer may react with another cyclic siloxane oligomer.

The invention includes embodiments that relate to a siloxane oligomer comprising the reaction product of a silicon hydride or a Si—H functional siloxane; a cyclic siloxane oligomer; and a Lewis acid. The silicon hydride and the Si—H functional siloxane have a hydrogen that is pendant from a silicon atom. The Lewis acid may be operable to interact with the pendant hydrogen. The interaction may enable the hydrogen to promote a ring opening of the cyclic siloxane oligomer to form a polysiloxane segment that is insertable between the pendant hydrogen and the silicon atom.

### DETAILED DESCRIPTION

The invention includes embodiments that relate to a method for using silicon hydride bearing molecules to produce a Si—H functional siloxane oligomer. In one embodiment, the reaction may be characterized as between a silicon hydride moiety with a cyclic siloxane oligomer composition. In one embodiment, the reaction may be characterized as a telomerization reaction. A siloxane oligomer may be provided in another embodiment of the invention.

A telomer may include one or more macromolecules or oligomer molecules having a few, usually terminal, reactive functional groups enabling, under appropriate conditions, the formation of larger macromolecules.

Suitable silicon hydride compositions suitable for use in embodiments of the invention may include, but are not limited to, one or more of trialkylsilanes, dialkylarylsilanes, alkyldiarylsilanes, triarylsilanes, dialkylsilanes, alkylarylsilanes, diarylsilanes, alkylsilanes, arylsilanes, and mixtures thereof. In one embodiment, the silicon hydride composition may include one or more of trimethylsilane (Me₃SiH), triethylsilane (Et₃SiH), diphenylmethylsilane (Ph₂MeSiH), phenyldimethylsilane (PhMe₂SiH), dimethylsilane (Me₂SiH₂), diethylsilane (Et₂SiH₂), diphenylsilane (Ph₂SiH₂), methylsilane (MeSiH₃), or phenylsilane (PhSiH₃).

Suitable Si—H functional siloxane compositions suitable for use in embodiments of the invention include, but are not limited to, linear and/or branched alkyl polysiloxanes, aryl polysiloxanes, alkylaryl polysiloxanes, and the like. In one embodiment, the polysiloxanes may include, for example, one or more of 1,1,3,3-tetramethyldisiloxane (HSiMe₂OSiMe₂H), 1,1,3,3-tetraphenyldisiloxane (HSiPh₂OSiPh₂H), 1,1,5,5-tetramethyl-3,3-diphenyl-trisiloxane (HSiMe₂OSiPh₂OSiMe₂H), pentamethyldisiloxane (SiMe₃OSiMe₂H), tris(dimethyl siloxy) methylsilane (MeSi(OSiMe₂H)₃), tris (dimethyl siloxy)phenyl silane (PhSi(OSiMe₂H)₃), tetrakis (dimethyl siloxy) silane (Si(OSiMe₂H)₄), and the like.

Suitable cyclic siloxane oligomer compositions may include, but are not limited to alkyl cyclo polysiloxanes, aryl cyclo polysiloxanes, alkyl aryl cyclo polysiloxanes, and the like. Suitable mixtures of the foregoing may include, for example, one or more of hexamethyl cyclo trisiloxane, trimethyl cyclo trisiloxane, triphenyl-trimethyl cyclo trisiloxane hexaphenyl cyclo trisiloxane, and trimethyl tris (trifluoro propyl)cyclo trisiloxane.

In one embodiment, a cyclic siloxane oligomer may be represented by

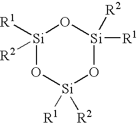

where R¹ and R² may be independently selected from hydrogen or the group of one to twelve carbon atom monovalent hydrocarbon radicals that may or may not be substituted with halogens (halogen being F, Cl, Br and I), e.g., non limiting examples being fluoroalkyl substituted or chloroalkyl substituted.

In one embodiment, the method may include a catalyst. A suitable catalyst for this reaction is an acid catalyst. Suitable acid catalysts may include the “proton donor” Bronsted-Lowry acid type and the “electron-pair acceptor” Lewis acid type. For ease of reference, hereinafter a reference to a Lewis acid includes both the “electron-pair acceptor” and the “proton donor” acids, unless context or language indicates otherwise. A suitable Lewis acid may include boron trifluoride (BF₃). The ability of any particular Lewis acid to catalyze the new reaction of embodiments of the invention will be a function of acid strength, steric hindrance of both the acid and the substrate, chemical stability in the reaction medium and solubility of the Lewis acid and the substrate in the reaction medium. The following Lewis acids: FeCl₃, AlCl₃, ZnCl₂, ZnBr₂, and BF₃ are only sparingly soluble in siloxane solvents. Lewis acid catalysts having a greater solubility in siloxane media may be used to decrease the require amount of catalyst needed. Such catalysts having increased solubility may include Lewis acid catalysts of Formula (I)

MR³_{b}X_{c} (I)

wherein M is B, Al, Ga, In or Tl; each R³ is independently the same (identical) or different and represent a monovalent aromatic hydrocarbon radical having from 6 to 14 carbon atoms, such monovalent aromatic hydrocarbon radicals may have at least one electron-withdrawing element or group such as, for example, —CF₃, —NO₂ or —CN, or substituted with at least two halogen atoms; X is a halogen atom; b is 1, 2, or 3; and c is 0, 1 or 2; with the proviso that b+c=3. Particularly suitable Lewis acid catalysts include Lewis acid catalysts of Formula (II)

BR³_{b}X_{c} (II)

wherein each R³ are independently the same (identical) or different and represent a monovalent aromatic hydrocarbon radical having from 6 to 14 carbon atoms, such monovalent aromatic hydrocarbon radicals preferably having at least one electron-withdrawing element or group such as —CF₃, —NO₂ or —CN, or substituted with at least two halogen atoms; X is a halogen atom; b is 1, 2, or 3; and c is 0, 1 or 2; with the proviso that b+c=3. In one embodiment, the catalyst comprises B(C₆F₅)₃.

Embodiments of the invention may use a Lewis acid catalyst concentration in a range of from about 1 part per million by weight (wppm) to about 10 weight percent (based on the total weight of siloxanes being reacted, 10 weight percent may be about equal to 100,000 wppm). In one embodiment, a Lewis acid catalyst concentration range may be from about 10 part per million by weight (wppm) to about 5 weight percent (50,000 wppm). Another suitable Lewis acid catalyst concentration range may be from about 50 wppm to about 10,000 wppm. Another suitable Lewis acid catalyst concentration range may be from about 10 wppm to about 50 wppm. Yet another suitable Lewis acid catalyst concentration range may be from about 50 wppm to about 5,000 wppm. Another suitable Lewis acid catalyst concentration range may be from about 5,000 wppm to about 10,000 wppm.

The telomerization reaction may be done without solvent or in the presence of solvents. The presence of solvents may be beneficial due to an increased ability to control viscosity, rate of the reaction and exothermicity of the process. Suitable solvents include aliphatic hydrocarbons, aromatic hydrocarbons, halogenated hydrocarbons, as well as oligomeric diorganosiloxanes such as hexamethyldisiloxane and octamethylcyclotetrasiloxane.

In one embodiment, the telomerization reaction between the (≡Si—H) moiety and the cyclic siloxane moiety may be conducted at an ambient temperature. In one embodiment, the reaction may be performed at an elevated temperature. Reaction rate and other reaction parameters may be controlled by, for example, controlling one or more of the temperature, the chemical structure of one or more reagents, the chemical structure of one or more catalysts, the concentration of the catalyst and/or reagents, and the amount and type of the solvent or solvents used.

In one embodiment, the telomerization reaction may be accomplished in the presence of a Lewis acid catalyst. In one embodiment, B(C₆F₅)₃ is used as the catalyst. The catalyst concentration is as described previously.

The Si—H functional siloxane oligomer produced according to the method or process may be suitable intermediates in the fields of, for example, siloxane elastomers, siloxane coatings, insulating materials, and cosmetic products.

Silicon is a tetravalent element and for purposes of descriptive convenience herein, not all four bonds of the silicon atom have been described in some of the abbreviated chemical reaction scenarios used to explain the reaction chemistry involved in the formation of non-hydrolytic silicon oxygen bonds. Where silicon is hypovalent or hypervalent in terms of its customary stereochemistry, the full structure has been indicated.

Telomerization of reactant products of embodiments of the invention may proceed with reference to the following example involving the reaction between a hydrosilane and a hexamethyl cyclo trisiloxane. Reaction of Et₃SiH may proceed relatively slowly and may lead to one or more reaction products. The products may differ from each other because a first telomer is formed slowly and consecutive reactions of the first telomer dominates the pattern of the process.

In the case of a relatively more reactive PhMe₂SiH, the reaction with hexamethyl cyclo trisiloxane may form a relatively high concentration of the first telomer

PhMe₂SiH+(Me₂SiO)₃→PhMe₂Si(OSiMe₂)₃H

The first telomer may further react with hexamethylcyclotrisiloxane to form a second telomer

PhMe₂Si(OSiMe₂)₃H+(Me₂SiO)₃→PhMe₂Si(OSiMe₂)₆H

In one embodiment, the process may include interacting one or both of a silicon hydride or of a Si—H functional siloxane with the Lewis acid. The Lewis acid may interact with a hydrogen that is pendant from a silicon atom of at least one of the silicon hydride or of the Si—H functional siloxane. The pendant hydrogen, subsequent to or during the interaction, may be enabled to open a ring of a cyclic siloxane oligomer and to form the open ring as a polysiloxane segment. The polysiloxane segment may insert between the interacted hydrogen and the silicon atom to form a telomer. In one embodiment, the telomer may react with at least another cyclic siloxane oligomer.

### EXAMPLES

Experimental Procedure: Reactions of the following examples are performed in a glass 10 ml reactor equipped with magnetic stirrer and a three-way glass stopcock connected to a nitrogen gas circulating system fitted with bubbler. The reactor is thermostated on a silicone oil bath. The reactor is purged with nitrogen and known amounts of substrates and gas chromatographic standard are introduced by means of tight precision Hamilton syringes using the three-way stopcock through which nitrogen is flowing. The zero sample is withdrawn by a Hamilton syringe and known amount of the solution of B(C₆F₅)₃ in toluene is introduced to reaction mixture. Samples are withdrawn at timed intervals and introduced to Eppendorfer vessels containing 4-ethylpyridine used for the quenching of the reaction. Time of the introduction of the sample to the amine is considered as the time of reaction. The chemical composition of the reaction mixture is established by gas chromatography analysis.

### Example 1

Reaction of hexamethylcyclotrisiloxane (D₃) with PhMe₂SiH. This reaction is carried out in accordance with the Experimental Procedure described above. 1.60 g of D₃ is sublimed on a high vacuum line into the reactor to which 2.93 g of PhMe₂SiH reagent. 0.0517 of toluene solution containing 1.01×10⁻⁴ mol of B(C₆F₅)₃ catalyst such that [B(C₆F₅)₃] is 1.87×10⁻² molkg⁻¹ solution is introduced by means of a precision Hamilton syringe. Temperature of the reaction is 24.2° C. Results are shown in Table 1.

TABLE 1
Results of Example 1

| | | | D₃ | | | 1^{st} Telomer |
|---|---|---|---|---|---|---|
| | Time | D₃ | % | PhMe₂SiH | PhMe₂SiH | PhMe₂Si(OSi)₃H |
| | (s) | Rel Int | conv | Rel Int | % conv | Rel Int |
| 1 | 0 | 3.21 | 0 | 6.92 | 0 | 0 |
| 2 | 20 | 3.12 | 3 | 6.36 | 8 | 0.064 |
| 3 | 90 | 2.78 | 13.5 | 6.15 | 11 | 0.140 |
| 4 | 210 | 2.36 | 26.5 | 6.12 | 11.5 | 0.38 |
| 5 | 360 | 1.83 | 43 | 5.72 | 17.5 | 0.64 |
| 6 | 640 | 1.18 | 63 | 5.11 | 26 | 0.92 |
| 7 | 1200 | 0.451 | 86 | 4.29 | 38 | 0.84 |
| 8 | 2400 | 0.180 | 94.5 | 3.56 | 48.5 | 0.62 |
| 9 | 5000 | 0.045 | 98.6 | 3.49 | 49.0 | 0.397 |
| 10 | 22700 | minor | >99.5 | 3.53 | 49.5 | 0.333 |
| 11 | 29500 | minor | >99.5 | 3.14 | 55 | 0.315 |

### Example 2

Reaction of hexamethylcyclotrisiloxane (D₃) with PhMe₂SiH. This reaction is carried out in accordance with the Experimental Procedure described above. 1.19 g of D₃ is sublimed on a high vacuum line into the reactor to which 0.796 g of PhMe₂SiH reagent and 2.42×10⁻² molkg⁻¹ of B(C₆F₅)₃ catalyst are added. Temperature of the reaction is 25° C. The first Telomer is PhMe₂Si(OSi)₃H and the second Telomer is PhMe₂Si(OSi)₆H. The reaction is monitored by GC and the results are shown in Table 2.

TABLE 2
Results of Example 2

| | | D₃ | | | | 1^{st} | 2nd |
|---|---|---|---|---|---|---|---|
| | Time | Rel | D₃ | PhMe₂SiH | PhMe₂SiH | Telomer | Telomer |
| | (s) | Int | % conv | Rel Int | % conv | Rel Int | Rel Int |
| 1 | 0 | 3.08 | 0 | 2.53 | 0 | 0 | 0 |
| 2 | 29 | 2.86 | 7.1 | 2.13 | 15.9 | 0.041 | 0 |
| 3 | 110 | 2.67 | 13.4 | 2.02 | 20 | 0.111 | 0 |
| 4 | 200 | 2.44 | 20.6 | 1.96 | 22.4 | 0.204 | 0 |
| 5 | 320 | 2.33 | 24.4 | 1.72 | 32.1 | 0.345 | 0 |
| 6 | 540 | 1.98 | 35.8 | 1.53 | 39.5 | 0.501 | minor |
| 7 | 1200 | 1.24 | 59.7 | 1.03 | 59.4 | 0.661 | 0.092 |
| 8 | 2400 | 0.565 | 81.7 | 0.653 | 74.3 | 0.540 | 0.149 |
| 9 | 3600 | 0.235 | 92.4 | 0.522 | 79.4 | 0.312 | 0.164 |
| 10 | 6700 | 0.046 | 98.5 | 0.498 | 80.3 | 0.099 | 0.078 |
| 11 | 10800 | 0.045 | 98.5 | 0.496 | 80.4 | 0.100 | 0.079 |
| 12 | 22500 | 0.032 | 99.0 | 0.395 | 84.4 | 0.059 | 0.047 |

### Example 3

Reaction of hexamethylcyclotrisiloxane (D₃) with 1,1,3,3-tetramethyldisiloxane (^{H}MM^{H}) The reaction of D₃ with ^{H}MM^{H} is performed in concentrated toluene solution using equimolar ratio of substrates and using an excess of D₃. Amounts of the specific ingredients are set forth in Table 3 for Examples 3a and 3b. The reaction is carried out in room temperature under nitrogen in a 10 ml thermostated reactor equipped with magnetic stirrer and a three way glass stopcock connected to a nitrogen gas circulating system fitted with bubbler. An amount of D₃ is sublimed on a high vacuum line into the reactor which is then filled with nitrogen gas and an amount of ^{H}MM^{H}, of ABCR (97%) purified by keeping over fresh CaH₂, dodecane and prepurified toluene are placed in the reactor by means of Hamilton syringes under positive pressure of nitrogen. An amount of the stock solution of the catalyst, B(C₆F₅)₃, in toluene is introduced by a precision Hamilton syringe. The time of the catalyst introduction is considered as the zero time of the reaction. Samples are withdrawn by means of Hamilton syringe and analyzed by gas chromatography (GC). Results for Examples 3a and 3b are found in Tables 4 and 5.

TABLE 3
Reactants composition for Examples 3a and 3b.

| Example | D₃ | ^{H}MM^{H} | C₁₂H₂₆ | Toluene | B(C₆F₅)₃ |
|---|---|---|---|---|---|
| 3a | 2.92 g | 1.73 g | 0.17 g | 3.03 g | 1.27 × 10⁻³ molkg⁻¹ |
| | 1.67 molkg⁻¹ | 1.64 molkg⁻¹ | 1.27 molkg⁻¹ | | |
| 3b | 1.884 g | 0.389 g | 0.221 g | 1.73 g | 9.67 × 10⁻³ molkg⁻¹ |
| | 1.904 molkg⁻¹ | 0.651 molkg⁻¹ | 0.292 molkg⁻¹ | | |

TABLE 4
Results of Example 3a.

| | Time | [D₃] | [^{H}MM^{H}] | | | | |
|---|---|---|---|---|---|---|---|
| | (s) | molkg⁻¹ | molkg⁻¹ | ^{H}MDM^{H} | ^{H}MD₂M^{H} | ^{H}MD₃M^{H} | cyclics |
| 1 | 0 | 1.635 | 1.668 | — | — | — | — |
| 2 | 26 | 0.678 | 1.454 | 0.375 | 0.197 | 0.1086 | 0.0147 |
| 3 | 52 | 0.412 | — | 0.435 | 0.241 | 0.1511 | 0.0243 |
| 4 | 102 | 0.241 | 1.319 | 0.518 | 0.292 | 0.190 | 0.0312 |
| 5 | 156 | 0.1285 | 1.180 | 0.515 | 0.304 | 0.199 | 0.0362 |
| 6 | 232 | 0.1073 | — | 0.507 | 0.309 | 0.2021 | 0.0667 |
| 7 | 317 | 0.0725 | 1.104 | 0.405 | 0.268 | 0.1907 | 0.0927 |
| 8 | 539 | 0.0527 | 0.983 | 0.387 | 0.2775 | 0.1611 | 0.1148 |
| 9 | 800 | 0.0413 | 0.925 | 0.345 | 0.2626 | 0.1548 | 0.0156 |
| 10 | 1130 | 0.0447 | 0.899 | 0.328 | 0.2624 | 0.1310 | 0.188 |
| 11 | 3560 | 0.0281 | 0.497 | 0.1374 | 0.1964 | 0.0271 | 0.250 |
| 12 | 6200 | 0.0053 | 0.245 | 0.0053 | 0.1277 | 0.0105 | 0.276 |
| 13 | 84000 | — | — | 0.0006 | 0.0241 | — | — |

TABLE 5
Results of Example 3b.

| | Time | [^{H}MM^{H}] | [D₃] | | | | | | |
|---|---|---|---|---|---|---|---|---|---|
| | (s) | molkg⁻¹ | molkg⁻¹ | ^{H}MDM^{H} | ^{H}MD₂M^{H} | ^{H}MD₃M^{H} | ^{H}MD₄M^{H} | ^{H}MD₅M^{H} | ^{H}MD₆M^{H} |
| 1 | 0 | 0.651 | 1.904 | — | — | — | — | — | — |
| 2 | 21 | 0.335 | 1.742 | 0.0494 | 0.0406 | 0.0415 | 0.0074 | — | — |
| 3 | 77 | 0.144 | 1.612 | 0.1188 | 0.0806 | 0.1112 | 0.0107 | — | — |
| 4 | 160 | 0.0629 | 1.547 | 0.1235 | 0.0895 | 0.1327 | 0.0160 | 0.0056 | 0.0042 |
| 5 | 265 | 0.0288 | 1.561 | 0.1365 | 0.1081 | 0.1421 | 0.0222 | 0.0093 | 0.0072 |
| 6 | 372 | 0.0226 | 1.413 | 0.107 | 0.0964 | 0.1246 | 0.0246 | 0.0120 | 0.0096 |
| 7 | 487 | 0.0150 | 1.369 | 0.1028 | 0.1031 | 0.1144 | 0.0281 | 0.0154 | 0.0121 |
| 8 | 782 | 0.0119 | 1.358 | 0.0949 | 0.1074 | 0.0848 | 0.0332 | 0.0222 | 0.0161 |
| 9 | 1105 | 0.0099 | 1.252 | 0.0781 | 0.1028 | 0.0590 | 0.0384 | 0.0301 | 0.0185 |
| 10 | 2130 | — | 1.355 | 0.0825 | 0.1276 | 0.0170 | 0.0504 | 0.0502 | 0.0204 |
| 11 | 50000 | — | 1.252 | 0.0781 | 0.1028 | 0.059 | 0.0284 | 0.0301 | 0.0185 |

### Comparative Example 4

Reaction of octamethylcyclotrisiloxane (D₄) with PhMe₂SiH. This reaction is carried out in accordance with the Experimental Procedure described above. 2.87 g of D₄ and 1.31 g of PhMe₂SiH are added by means of Hamilton syringes under positive pressure of nitrogen into the reactor. Subsequently, 0.0556 g (2.17×10⁻² molkg⁻¹) of B(C₆F₅)₃ catalyst is added. Temperature of the reaction is 25° C. The reaction is monitored by GC. The conversions of Si—H and D₄ as well as the formation of the expected siloxane oligomers are not observed even after 20 hrs.

The foregoing examples and description are merely illustrative of the invention, serving to illustrate only some of the features of embodiments of the invention. The appended claims are intended to claim the invention as broadly as it has been conceived and the examples herein presented are illustrative of selected embodiments from a manifold of all possible embodiments. The appended claims are not to be limited by the choice of examples utilized to illustrate features of embodiments of the invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. A process for making a Si—H functional siloxane oligomer, comprising:
reacting at least one of a silicon hydride or a Si—H functional siloxane with both a cyclic siloxane oligomer and a Lewis acid, wherein a pendant hydrogen of the silicon hydride or of the Si—H functional siloxane promotes ring opening of the cyclic siloxane oligomer to form a polysiloxane segment, and the polysiloxane segment inserts between the hydrogen and the silicon atom from which the hydrogen was pendant.

2. The process as defined in claim 1 wherein said cyclic siloxane oligomer has the formula 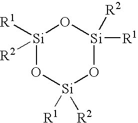
wherein R¹ and R² may be independently selected from hydrogen, a group of one to twelve carbon atom monovalent hydrocarbon radicals, a group of one to about twelve carbon atom monovalent hydrocarbon radicals substituted with one or more halogens, and combinations of two or more thereof.

3. The process as defined in claim 1 wherein the Lewis acid catalyst comprises a composition of the formula:
MR³_{b}X_{c}
wherein M is selected from the group consisting of B, Al, Ga, In and Tl; each R³ is independently selected from the group of monovalent aromatic hydrocarbon radicals having from 6 to 14 carbon atoms; X is a halogen atom selected from the group consisting of F, Cl, Br, and I; b is 1, 2, or 3; and c is 0, 1 or 2; subject to the requirement that b+c=3.

4. The process as defined in claim 3 wherein each R³ is C₆F₅ and b=3.

5. The process as defined in claim 3 where M is boron.

6. The process as defined in claim 1 wherein the Lewis acid catalyst is tri(pentafluorophenyl)boron.

7. The process as defined in claim 1 wherein the Lewis acid is present in a concentration in a range of from about 10 wppm to about 50,000 wppm.

8. The process as defined in claim 1 wherein said cyclic siloxane oligomer comprises one or more cyclic trisiloxane oligomers.

9. The process as defined in claim 1 wherein said cyclic siloxane oligomer is selected from the group consisting of hexamethyl cyclo trisiloxane, triphenyl trimethyl cyclo trisiloxane, trimethyl tris (trifluoro propyl)cyclo trisiloxane, and hexaphenyl cyclo trisiloxane.

10. The process as defined in claim 1 wherein said polysiloxane segment is a trisiloxane segment.

11. The process as defined in claim 1 wherein the Si—H functional siloxane comprises one or more alkyl polysiloxane, aryl polysiloxane, or alkylaryl polysiloxane.

12. The process as defined in claim 1 further comprising providing thermal energy.

13. The process as defined in claim 1 wherein one or both of the silicon hydride or the Si—H functional siloxane comprises one or more trialkylsilane, dialkylarylsilane, alkyldiarylsilane, triarylsilane, dialkylsilane, alkylarylsilane, diarylsilane, alkylsilane, or arylsilane.

14. A Si—H functional siloxane oligomer prepared by the process as defined in claim 1.

15. A process, comprising:
interacting one or both of a silicon hydride or of a Si—H functional siloxane with a Lewis acid, the Lewis acid being operable to interact with a hydrogen that is pendant from a silicon atom of at least one of the silicon hydride or of the Si—H functional siloxane;
opening a ring of a cyclic siloxane oligomer using the interacted hydrogen to form a polysiloxane segment;
inserting the polysiloxane segment between the interacted hydrogen and the silicon atom to form a telomer; and
reacting the telomer with at least another cyclic siloxane oligomer.

16. The process as defined in claim 15 wherein said cyclic siloxane oligomer has the formula 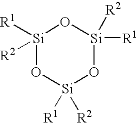
wherein R¹ and R² may be independently selected from hydrogen, a group of one to twelve carbon atom monovalent hydrocarbon radicals, a group of one to twelve carbon atom monovalent hydrocarbon radicals substituted with one or more halogens, and combinations thereof.

17. The process as defined in claim 15 wherein the Lewis acid catalyst comprises a composition of the formula:
MR³_{b}X_{c}
wherein M is selected from the group consisting of B, Al, Ga, In and TI; each R³ is independently selected from the group of monovalent aromatic hydrocarbon radicals having from 6 to 14 carbon atoms; X is a halogen atom selected from the group consisting of F, Cl, Br, and I; b is 1, 2, or 3; and c is 0, 1 or 2; subject to the requirement that b+c=3.

18. The process as defined in claim 16 where M is boron.

19. The process claim 16 wherein each R³ is C₆F₅ and b=3.

20. The process as defined in claim 15 wherein the Lewis acid catalyst is tri(pentafluorophenyl)boron.

21. The process as defined in claim 15 wherein the concentration of the Lewis acid catalyst ranges from about 10 wppm to about 50,000 wppm.

22. The process as defined in claim 15 wherein said cyclic siloxane oligomer comprises a cyclic trisiloxane oligomer.

23. The process as defined in claim 15 wherein said cyclic siloxane oligomer is selected from the group consisting of hexamethyl cyclo trisiloxane, triphenyl trimethyl cyclo trisiloxane, and trimethyl tris (trifluoropropyl)cyclo trisiloxane.

24. The process as defined in claim 15 wherein said polysiloxane segment is a trisiloxane segment.

25. The process as defined in claim 15 wherein one or both of the silicon hydride or the Si—H functional siloxane comprises one or more trialkylsilane, dialkylarylsilane, alkyldiarylsilane, triarylsilane, dialkylsilane, alkylarylsilane, diarylsilane, alkylsilane, or arylsilane.

26. The process as defined in claim 15 further comprising providing thermal energy.

27. Any one of an intermediate for a siloxane elastomers, a siloxane elastomers, an intermediate for an insulating material, an insulating material, an intermediate for a cosmetic product, a cosmetic product, siloxane foam, a siloxane coating, a hyperbranched silicone polymer, across-linked siloxane network, and a gel prepared by using the Si—H functional siloxane oligomer prepared by the process as defined in claim 1.

28. Any one of an intermediate for a siloxane elastomers, a siloxane elastomers, an intermediate for an insulating material, an insulating material, an intermediate for a cosmetic product, a cosmetic product, a siloxane foam, a siloxane coating, a hyperbranched silicone polymer, across-linked siloxane network, and a gel prepared by using the Si—H functional siloxane oligomer prepared by the process as defined in claim 15.

29. A siloxane oligomer comprising the reaction product of:
a silicon hydride or a Si—H functional siloxane, wherein the silicon hydride and the Si—H functional siloxane have a hydrogen that is pendant from a silicon atom;
a cyclic siloxane oligomer; and
a Lewis acid that is operable to interact with the pendant hydrogen, wherein the interaction enables the hydrogen to promote a ring opening of the cyclic siloxane oligomer to form a polysiloxane segment that is insertable between the pendant hydrogen and the silicon atom.
